(19) United States
(12) Patent Application Publication
(10) Pub. No.: US 2015/0239074 A1
(43) Pub. Date: Aug. 27, 2015

(54) Welding Wheel Electrode Apparatus and Method

(71) Applicants: Art Parmely, Houston, TX (US); Carl Cooper, Houston, TX (US); Steven Mark Everritt, Houston, TX (US); Richard Grifno, Houston, TX (US)

(72) Inventors: Art Parmely, Houston, TX (US); Carl Cooper, Houston, TX (US); Steven Mark Everritt, Houston, TX (US); Richard Grifno, Houston, TX (US)

(73) Assignee: DELTA SCREEN & FILTRATION, LLC, Houston, TX (US)

(21) Appl. No.: 14/623,042

(22) Filed: Feb. 16, 2015

Related U.S. Application Data
(60) Provisional application No. 61/944,354, filed on Feb. 25, 2014.

(51) Int. Cl. B23K 35/40

(52) U.S. Cl. CPC B23K 35/402

(57) ABSTRACT

Embodiments of a wire wrapping system generally include a welding wheel electrode mounted on a support assembly, wherein the support assembly is moveable laterally and vertically to a welding position, and moveable laterally and vertically to a sharpening location where a sharpening mechanism can engage the welding wheel electrode contact surface. Embodiments of a method of sharpening a welding wheel electrode contact surface generally include installing the welding wheel on a support assembly that is moveable laterally and vertically to a welding position, and moveable laterally and vertically to a fixed sharpening location, installing a sharpening mechanism, manipulating the support assembly to move the welding wheel electrode to the sharpening location where the sharpening mechanism engages the welding wheel electrode contact surface, rotating the welding wheel electrode in relation to the sharpening mechanism, and laterally adjusting the support system to allow uniform sharpening of the welding wheel electrode contact surface.

### CROSS-REFERENCE TO RELATED APPLICATIONS

This application claims the benefit of U.S. Provisional Application No. 61/944,354 filed on Feb. 25, 2014, which application is incorporated herein by reference as if reproduced in full below.

### STATEMENT REGARDING FEDERALLY SPONSORED RESEARCH OR DEVELOPMENT

Not Applicable.

### BACKGROUND OF THE INVENTION

1. Field of the Invention

The present invention relates to manufacture of wire wrapped screens for oil, gas and water well pipe. More particularly, the present invention relates to a welding electrode apparatus and methods.

2. Description of the Related Art

Hydrocarbons are produced by drilling into subterranean hydrocarbon-bearing formations. Unconsolidated formation walls can result in sand, rock, or silt accumulating in wellbore, which can ultimately cause various problems in the drilling operation. Sand control has become increasingly important in the industry.

Well screens (also called filters) used in sand control applications can be of various types, including wire mesh and continuous slot wire wrapped. Continuous slot wire wrapped screens are composed of wire helically wrapped around multiple support ribs to form a cylindrical screen with a continuous helical slot. It is important that slot size is maintained within determined tolerances throughout the length of the screen.

Wire wrapped screens are typically manufactured using wire wrapping machines that simultaneously wrap the wire around, and weld the wire to, multiple support ribs, to form a hollow cylindrical well screen of a desired length. A headstock spindle rotates the ribs causing wire to be wrapped around the set of ribs.

Important aspects of the manufacturing process include consistent, uniform welds. To achieve uniform welds utilizing a welding wheel, it is necessary to provide a uniform welding wheel contact surface for engagement of work piece faying surfaces. Historically, welding wheel contact surfaces are sharpened by removing the welding wheel from the welding wheel assembly, installing the welding wheel on a rotating spindle, sharpening the welding wheel surface, and re-attaching the welding wheel to the welding wheel assembly.

The present invention provides an improved welding wheel apparatus and sharpening method.

### BRIEF SUMMARY OF THE INVENTION

Embodiments of a welding wheel electrode system and method for a wire wrapping system generally comprise mounting a welding wheel electrode on a welding wheel support assembly. In one embodiment, the support assembly is moveable laterally and vertically to a welding position wherein the welding wheel electrode contact surface engages work piece faying surfaces, and is further moveable laterally and vertically to a sharpening location wherein a fixed sharpening blade engages the welding wheel electrode contact surface.

One embodiment of a method of sharpening a welding wheel electrode contact surface comprises installing the welding wheel on a support assembly that is moveable laterally and vertically to a welding position, installing a sharpening blade, operating the support system to transfer the welding wheel electrode to a sharpening location, engaging the sharpening blade with the welding wheel contact surface transferred to a sharpening location, rotating the welding wheel in relation to the sharpening blade, and laterally adjusting the support system to allow uniform lateral sharpening of the welding wheel contact surface while rotating the welding wheel.

### BRIEF DESCRIPTION OF THE DRAWINGS

For a more complete understanding of embodiments of the invention, reference is now made to the following Detailed Description of Exemplary Embodiments of the Invention, taken in conjunction with the accompanying drawings, in which:

FIG. 1 is an illustrative view of a wire wrapping system with a welding wheel electrode assembly of an embodiment of the present invention.

FIG. 2 is a partial view of a mounting structure of an embodiment of the present invention.

FIG. 3 is a partial side view of an embodiment of a welding support assembly and mounting structure of the present invention.

FIG. 3A is a partial side view of an embodiment of a rotating spindle of the present invention.

FIG. 4 depicts an embodiment of a method of the present invention.

FIG. 5 depicts an embodiment of a welding wheel electrode contact surface proximate a work piece.

FIG. 6 depicts an embodiment of a welding wheel electrode contact surface proximate a sharpening blade.

FIG. 7 depicts a detail of an embodiment of a welding wheel electrode contact surface proximate a sharpening blade.

FIG. 8 depicts an embodiment of a method of the present invention.

### DETAILED DESCRIPTION OF EXEMPLARY EMBODIMENTS OF THE INVENTION

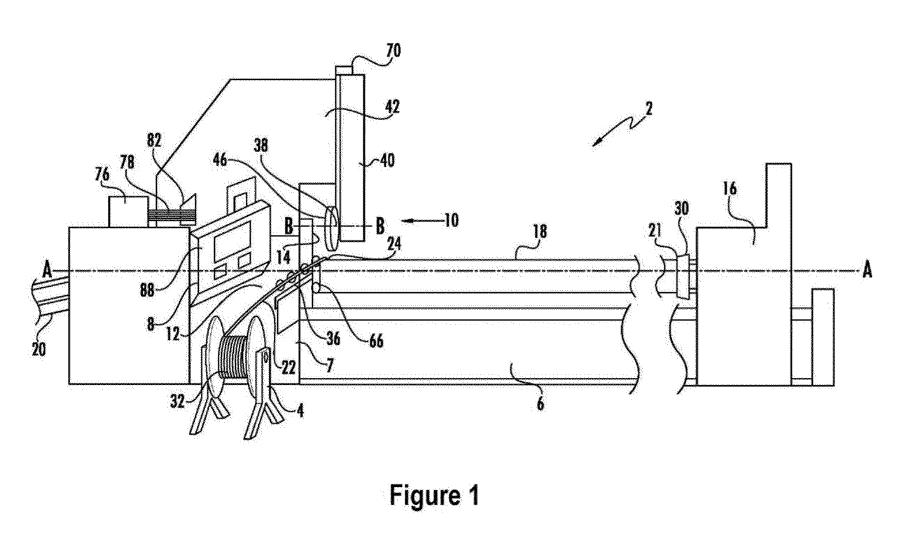

Referring now to the drawings, wherein like reference characters designate like or similar parts throughout, FIG. 1 depicts a wire wrapping system 2 having a welding pressure control assembly 10. Wire wrapping system 2 is used to manufacture wire wrapped well screens 18. Wire wrapping system 2 includes a wire feed assembly 4, bed 6, control module (panel) 8, welding pressure assembly 10, headstock 12, rotating headstock spindle 14, and tailstock 16.

A plurality of elongated support ribs 20 and wire 22 are used to form screen 18. Wire 22 is wrapped helically around the support ribs 20 and is welded at each contact point 24 of a rib 20 with wire 22. In this context, welding includes fusion welding, such as, but not limited to, electrical resistance welding. In an exemplary embodiment, welding is performed by a rotating welding wheel electrode 46 provided proximate headstock 12. In one embodiment, the welding wheel electrode 46 welds each wire 22 to corresponding ribs 20 at contact points 24 by electrical resistance welding.

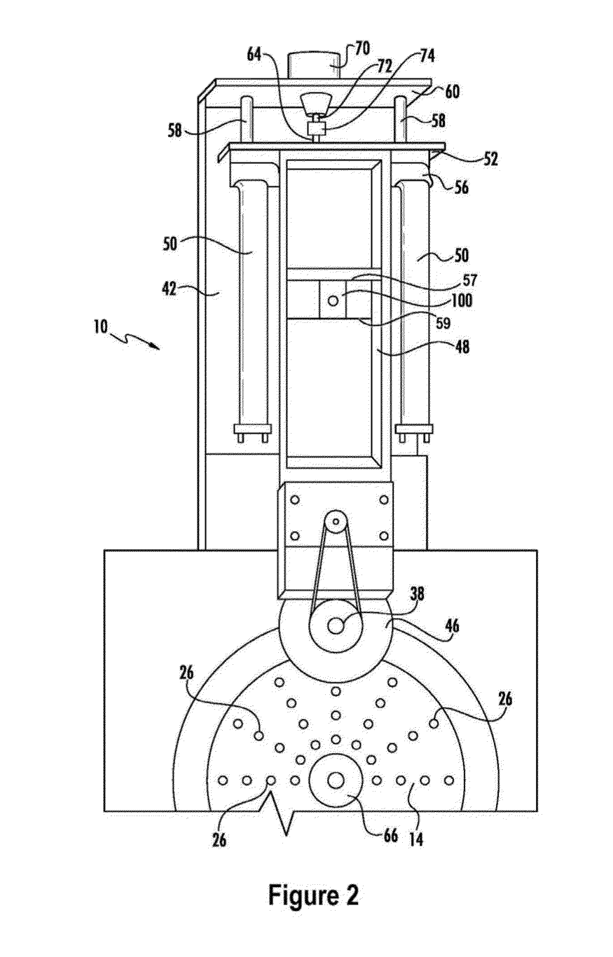

Headstock 12 is equipped with a rotating spindle 14. Spindle 14 rotates about axis A-A. Spindle 14 has a plurality of radially spaced rib openings 26 (shown in FIG. 2) through which ribs 20 extend. Openings 26 are spaced from spindle axis A-A at various distances and in patterns to allow multiple circular patterns of openings 26. In an exemplary embodiment, spindle 14 contains multiple circular patterns of openings 26 to allow construction of various diameters of screen 18.

Openings 26 allow ribs 20 to extend generally along axis A-A but spaced therefrom prior to welding. Other supports (not shown) intermediate headstock 12 and tailstock 16 support ribs 20 substantially parallel to and equally spaced from axis A-A after welding, if a screen 18 is being formed without a pipe section disposed there within.

Ribs 20 each have a first rib end 21 extending toward tailstock 16. A tailstock spindle 30 grasps rib ends 21 with a grasping mechanism (not shown) such as a pull ring or a chuck. Tailstock spindle 30 rotates about axis A-A.

Spindle 14 and tailstock spindle 30 are each driven to rotate about axis A-A by a rotary actuator, such as a servo motor (not shown). The servo motors driving spindle 14 and spindle 30 are each electronically connected to processor 88, which may be part of control panel 8. Rate of rotation may therefore be controlled by a processor 88.

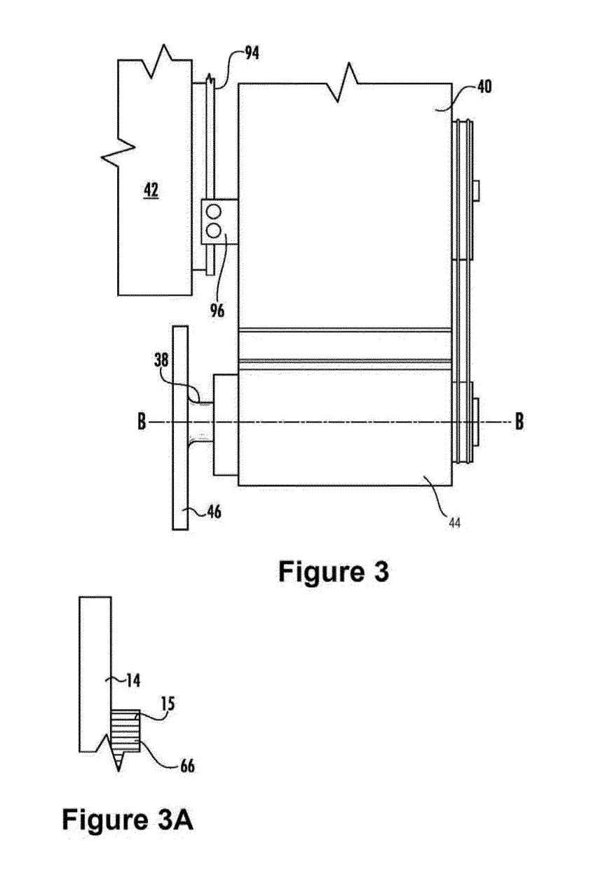

Head 66 is fixedly attached to spindle 14 and extends outward from the spindle 14 in the direction of the tailstock 16. As shown in FIG. 3A, head 66 is provided with cylindrical openings with milled longitudinal slots 15 sized and located to support ribs 20 and maintain rib 20 spacing. Head 66 serves as a support for ribs 20 and wire 22 during welding and comprises an electrode of the welding process. Head 66 may be of differing sizes for different screen 18 diameters. In one aspect wherein screen 18 is to be formed around a pipe, spindle 14 includes a centralized opening (not shown), in lieu of head 66, through which the pipe extends. Tailstock spindle 30 grasps the end of the pipe extending through spindle 14 with a grasping mechanism (not shown).

Headstock 12 is disposed proximate first bed end 7 of bed 6. Bed 6 is an elongate structure that extends along a longitudinal axis substantially parallel to, but offset from, axis A-A. Tailstock 16 is moveable along bed 6. Movement of tailstock 16 may be controlled by a conventional linear drive mechanism (i.e., linear actuator), such as a ball screw drive. In an exemplary embodiment of the present invention, tailstock 16 is moved and controlled by an induction linear guide. The driver (not shown) controlling movement of tailstock 16 is electronically connected to processor 88 to allow controlled movement of tailstock 16 along bed 6.

Wire feed assembly 4 is positioned proximate headstock 12. Wire feed assembly 4 includes a rotating wire feed spool 32 and wire guide 36. Wire guide 36 directs wire 22 toward support ribs 20.

Referring to FIGS. 2, and 3, welding assembly 10 is located proximate bed 6. Welding assembly 10 comprises a welding arm 38 positioned on welding support assembly 40 moveably positioned above bed 6. Support assembly 40 is supported by a mounting structure 42. Welding arm 38 is rotatable in relation to support assembly 40. A section of welding arm 38 extends through support assembly 40 and a section of welding arm 38 extends from support assembly 40 toward headstock 12. Welding wheel electrode 46 is mounted on welding arm 38 intermediate support assembly 40 and headstock 12. Welding wheel assembly 44, which includes welding arm 38, is mounted to the bottom surface of support assembly 40 extending downwardly therefrom. Welding wheel assembly 44 supports welding arm 38.

Mounting structure 42 is supported on headstock 12 and is laterally moveable parallel to axis A-A. In an exemplary embodiment, lateral movement of mounting structure 42 is controlled by a lateral linear actuator (not separately labeled) comprising servo motor 76, mounted on headstock 12, driving a ball screw shaft 78. Guides 82, mounted to mounting structure 42, interact with ball screw shaft 78, resulting in controlled lateral movement of mounting structure 42 responsive to operation of servo motor 76. Servo motor 76 is electronically connected to processor 88 of control panel 8 to provide controlled operation of servo motor 76 and consequent lateral movement of support structure 42.

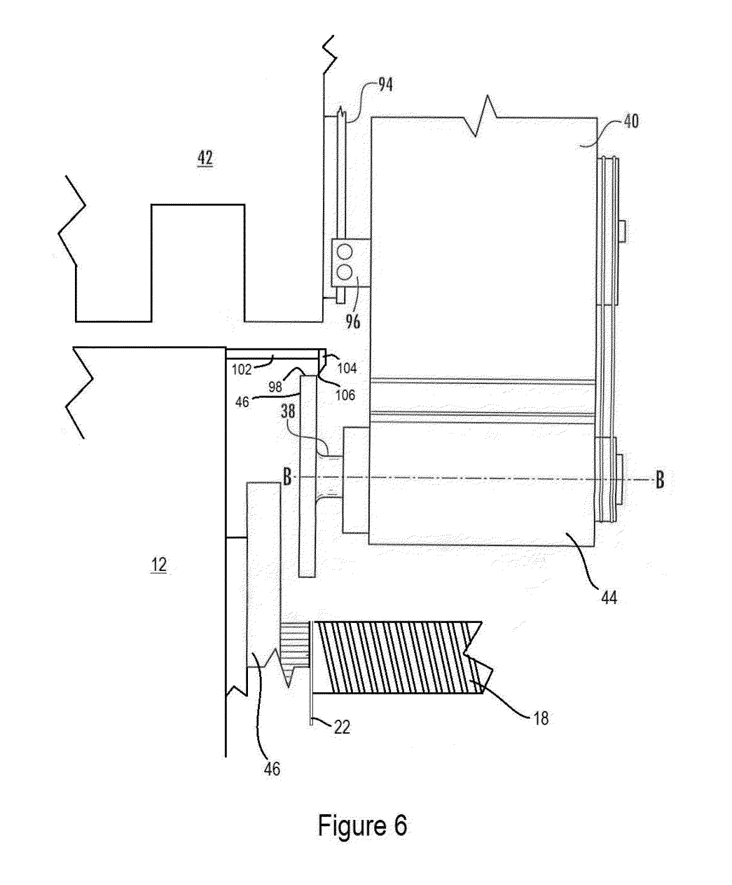

Welding wheel electrode 46 rotates on an axis of rotation depicted as B-B in FIGS. 1, 3, 5, and 6. Axis B-B is parallel to, but offset from, axis A-A. In an exemplary embodiment of the present invention, welding wheel electrode 46 may be adjustably biased against wire 22 to adjust the weld force applied by the welding wheel electrode 46 to wire 22.

Referring to FIGS. 2 and 3, welding support assembly 40 includes a vertical mounting frame 48 attached to a shelf 52. Cylinders 50, which in one aspect may be hydraulic and/or pneumatic, are attached to shelf 52 at mounting brackets 56. Cylinders 50 are placed on opposing sides of frame 48. A cylinder rod 58 extends from each cylinder 50 through shelf 52 to mounting bracket 60 of mounting structure 42. Cylinder rods 58 are attached to bracket 60. Cylinders 50 are each vertically oriented. Cylinders 50, cylinder rods 58, shelf 52, and bracket 60 are arranged to allow for controlled vertical movement of shelf 50, and accordingly, for controlled vertical movement of support assembly 40 in relation to mounting structure 42.

A motor 70 is provided on bracket 60 such that the motor shaft 72 extends vertically through bracket 60. A coupler 74 is mounted below bracket 60, connecting motor shaft 72 to lead screw 64. In one embodiment, lead screw 64 is a helically-threaded shaft of a ball screw type vertical linear actuator system (not separately labeled) (comprising motor 70, shaft 72, coupler 74, and screw 64). A ball nut (not shown) is attached to support assembly 40. Motor 70, lead screw 64 and the ball nut cooperatively allow controlled vertical movement of support assembly 40 in relation to mounting structure 42 by operation of motor 70. Motor 70 is electronically connected to processor 88 of control panel 8 to allow controlled operation of motor 70 and thereby controlled vertical movement of support assembly 40 and of electrode wheel 46.

Referring to FIG. 3, a side view of a guide channel 94 and a guide bracket 96 is shown. Two guide channels 94 are fixedly attached to mounting structure 42. Each guide channel 94 is vertically oriented. Guide brackets 96 are attached to support assembly 40. Guide brackets 96 and guide channels 94 are sized and structured to allow vertical movement of support assembly 40 in relation mounting structure 42, but to limit horizontal movement of support assembly 40 in relation to mounting structure 42.

A force measurement device (such as a load cell) 100 is provided in the welding assembly 10 to determine forces, and therefore pressure applied by the welding wheel electrode 46 to the wire 22 during a welding process. The load cell 100 is positioned intermediate mounting structure 42 structure contact plate 57 and support assembly 40 contact plate 59. Load cell 100 may comprise a commercially-available precision compression loading type load cell. Specifically, load cell 100 measures pressure forces applied to load cell 100 by structure contact plate 57 and support contact plate 59.

In an exemplary embodiment, load cell 100 is electronically connected to processor 88 of control panel 8 to provide continuous or intermittent communication of measured pressure forces. Accordingly, motor 70 may be operated as a closed loop process wherein load cell 100 measured forces are processed. Processor 88 control commands responsive to measured forces are provided pursuant to predetermined parameters to motor 70 thereby inducing operation of motor 70 to move support assembly 40 in relation to mounting structure 42 to increase or decrease applied force.

Welding wheel electrode 46 is supported in a fixed vertical orientation on support assembly 40 during a welding process. Spindle 14 on which head 66 is positioned is in a fixed vertical position in relation to mounting structure 42. Accordingly head 66, together with ribs 20 and wire 22 supported thereon, is positioned in a fixed vertical position in relation to mounting structure 42. Accordingly, for any given welding process, welding wheel 46 may be positioned on the faying surfaces of ribs 20 and wire 22. Upon calibration, the applied pressure of welding wheel 46 to faying surfaces of ribs 20 and wire 22 may be determined. Applied pressure may then be adjusted by relative movement of support assembly 40 in relation to mounting structure 42.

In one embodiment, cylinders 50 dampen the movement of support assembly 40 in relation to mounting structure 42, thereby allowing controlled pressure application with self-correcting, dampening adjustments for variations, such as variations resulting from rotation eccentricities of the welding wheel and spindle, welding wheel contact surface wear, and depth variations of faying surfaces.

Referring to the embodiment depicted in FIG. 1, the weld pressure assembly 10 of the present invention is adapted to be at least partially controlled by processor 88 in control module 8. Force readings from load cell 100 are transmitted to processor 88. Processor 88 is programmable to operate motor 70 and accordingly adjust position of support assembly 40 according to given conditions. Processor 88 is operable to, continually or intermittently, receive load data from load cell 100 and to adjust the vertical position of support assembly 40, via motor 70 to achieve a desired load level of welding wheel electrode 46 on wire 22. Such force level is indicated by load cell 100.

### Operation

In exemplary operation, ribs 20 are extended through openings 26 and wire 22 are positioned on a rib 20. Each rib 20 and wire 20 comprises faying surfaces for welding by welding wheel 46.

At the beginning of a welding process, welding wheel 46 is positioned on wire 22. The indicated pressure forces applied to load cell 100 are determined. Servo motor 70 is operated to provide a load of support assembly 40 in relation to structure 42, thereby providing a determined load of welding wheel 46 on faying surfaces of wire 22 and ribs 20. As welding wheel 46 is fixedly attached to support assembly 40, and wire 22 and rib 20 faying surfaces supported on spindle 14 are in a vertically fixed orientation in relation to mounting structure 42, the load applied by welding wheel 46 to wire 22 and rib 20 is also a determined force.

Pressure applied within cylinders 50 is electronically controlled to maintain a determined cylinder pressure to offset the weight load of support assembly 40. As cylinder rods 58 are mounted on mounting structure 42, cylinders 50 can be adjusted to provide a determined load on load cell 100 as load cell 100 measures load applied intermediate contact plate 57 of mounting structure 42 and contact plate 59 of support assembly 40. Accordingly, by application of appropriate dampening force by cylinders 50, the indicated load at load cell 100 between contact plates 57 and 59 can be set to zero (or other pre-determined force).

With the determined initial position, processor 88 is operated to control motor 70 to operate lead screw 64 to vertically bias support assembly 40 in relation to mounting structure 42 until a determined application load force is obtained. Load cell 100 indicates the load applied by welding wheel 46 to the faying surfaces of wire 22 and ribs 20.

As spindle 14 of headstock 12 is rotated and welding wheel 46 powered, the wire 22 is welded to successively rotated ribs 20. Rotation of spindle 14 results in wire 22 being drawn through a wire guide 34 from spool 32 during welding operation. In one embodiment, processor 88 of control panel 8 is operated during a welding process to rotate spindles 14 and 30 concurrently and at like rotation speeds, to control lateral movement of tailstock 16 and to control pressure applied by welding pressure assembly 10 during the welding process.

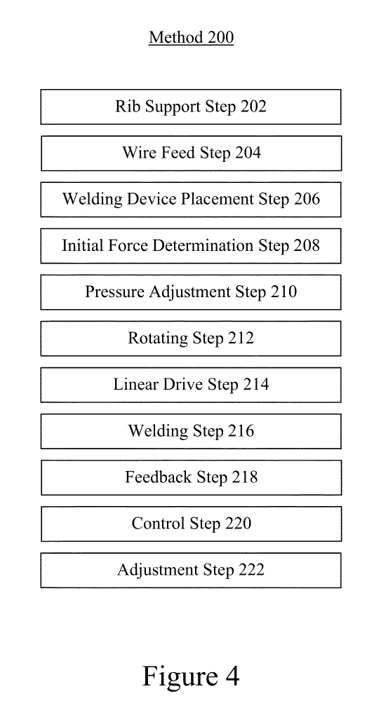

Referring to FIG. 4, a method 200 of an embodiment of the present invention is disclosed for providing controlled welding pressure in a wire wrap screen manufacturing process, the method comprising the steps indicated herein.

A rib support step 202 comprises providing a support for ribs 20, said support comprising a rotating head 66.

A wire feed step 204 comprises providing wire 22 to an intersecting surface of a rib 20.

A welding device placement step 206 comprises providing a welding device, such as welding wheel 46 supported on a support assembly 40, in contact with a wire 22 supported on a rib 20.

An initial force determination step 208 comprises determining pressure exerted on wire 20 by welding wheel 46. Such determination is made by load cell 100 and indicates the load of support assembly 40 in relation to mounting structure 42. Such reactive load is measured intermediate contact plate 57 and contact plate 59. Support assembly 40 is supported by a mounting structure 42.

A pressure adjustment step 210 comprises adjusting pressure of the welding wheel 46 on wire 22 to a predetermined level. Pressure adjustment step 210 is accomplished by adjusting pressure within cylinders 50. Pressure adjustment may be further accomplished by servo motor 70 as part of the vertical linear actuator.

A rotating step 212 comprises rotating spindle 14.

A linear drive step 214 comprises driving tailstock 16 along axis A-A away from headstock 12.

A welding step 216 comprises welding wire 22 to a rib 20 at each intersection of wire 22 and rib 20.

A feedback step 218 comprises continuous or intermittent measurement of indicated load intermediate contact plate 57 and contact plate 59.

A control step 220 comprises continuous or intermittent receipt of indicated load data, processing received data and output of control commands according to predetermined parameters.

An adjustment step 222 comprises operation of the vertical linear actuator system by servo motor 70 to move support assembly 40 in relation to mounting structure 42, thereby increasing or decreasing, as determined by operation parameters, pressure applied by welding wheel 46 to wire 22 and ribs 20.

In an embodiment of the present invention, feedback step 218 involves continuously or intermittently measuring various data in relation to the system, including rotation speed of spindle 14, rotation speed of spindle 30, and linear travel of tailstock 16. In such an embodiment, control step 220 includes receipt of indicated load data and data related to spindle 14 rotation speed, spindle 30 rotation speed, and linear travel of tailstock 16, processing the data, and output of control commands according to predetermined parameters. In such an embodiment, adjustment step 222 comprises adjustment of spindle 14 rotation speed, spindle 30 rotation speed, and linear travel of tailstock 16.

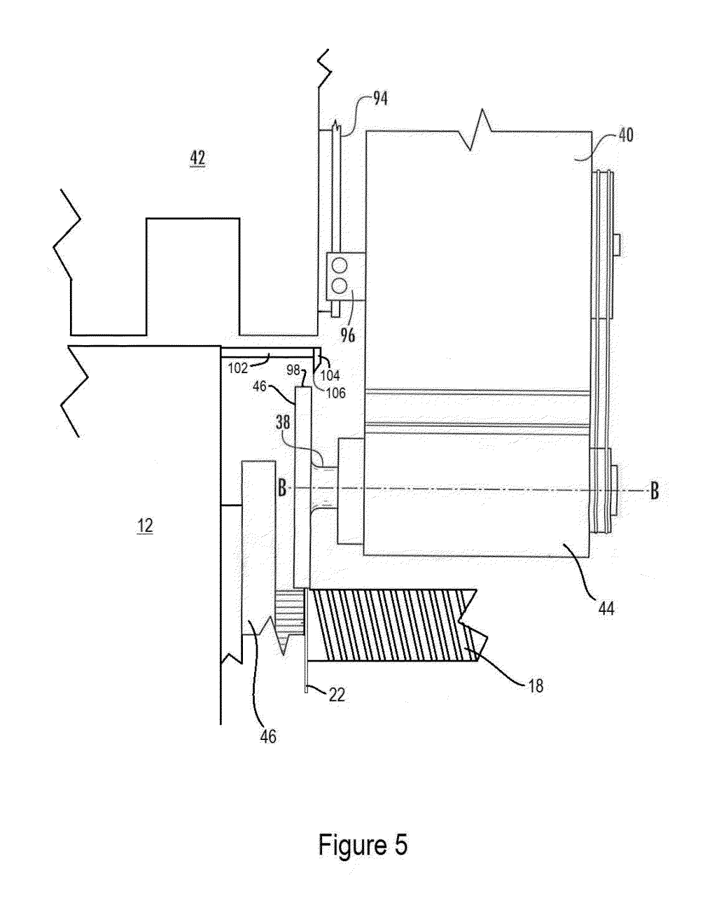

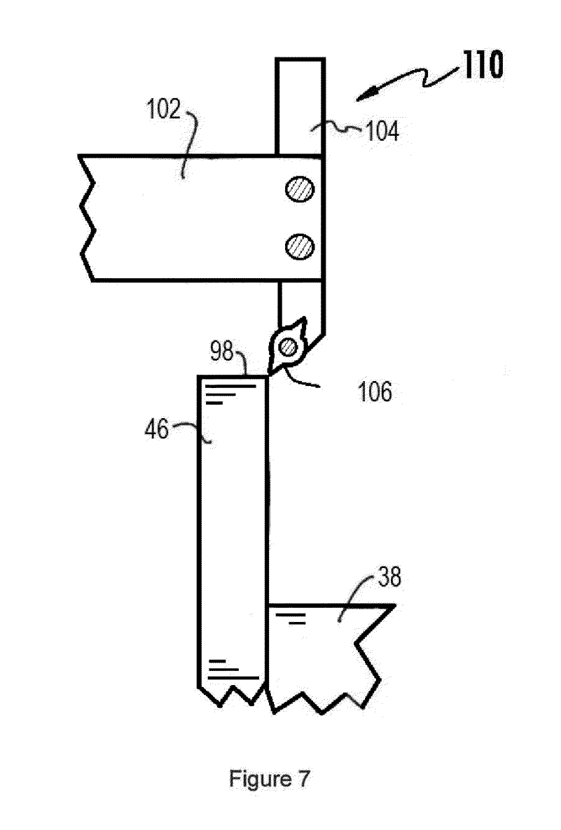

Now referring to FIGS. 5, 6, and 7, details of an embodiment of the welding wheel sharpening apparatus 110 of the present invention are depicted. In one embodiment, welding wheel sharpening apparatus 110 comprises a sharpening mechanism. In one embodiment, the sharpening mechanism comprises a sharpening arm 102, a sharpening blade 104, and a sharpening tip 106. In the exemplary embodiment described, sharpening arm 102 is attached to headstock 12. Sharpening arm 102 may be attached to headstock 12 by one or more mechanical fasteners, such as a bolt or the like, or may be integral to headstock 12. Sharpening arm 102 extends outwardly from headstock 12 in the direction of tailstock 16 and generally proximate welding wheel 46. In the exemplary embodiment depicted, sharpening blade 104 is attached to sharpening arm 102 distal headstock 12. Sharpening blade 104 may be attached to sharpening arm 102 by known mechanical means or may be integral to sharpening arm 102. In one embodiment, sharpening blade 104 is attached to sharpening arm 102 by one or more set screws. Sharpening blade 104 extends generally in the direction of a welding wheel electrode contact surface 98 of welding wheel 46. Sharpening blade 104 may comprise any suitable brazed or un-brazed material, such as but not limited to, metal, carbide, diamond, polycrystalline diamond (PCD), cubic boron nitride (CBN), or other mineral. In one embodiment, sharpening blade 104 comprises a brazed carbide. In the exemplary embodiment, a hardened sharpening tip 106 is provided on sharpening blade 104. Sharpening tip 106 may comprise the same or different materials as sharpening blade 104. In various embodiments, sharpening tip 106 comprises a brazed or un-brazed carbide. In additional embodiments, sharpening apparatus 110 may comprise an alternative sharpening mechanism, such as a rotating device (e.g., a grinding wheel), a particle dispeller (e.g., a water jet), or a radiation emitting device (e.g., a laser), in lieu of a sharpening blade 104. In various embodiments, including but not limited to, wherein the sharpening apparatus 110 comprises a water jet or a laser, engagement of the sharpening mechanism with the contact surface 98, whereby sharpening is accomplished, may not require abutment of the sharpening mechanism with the contact surface 98.

In one embodiment, in conjunction with a functionality to laterally adjust the position of welding wheel 46 in relation to headstock 12, and a functionality to vertically adjust the position of welding wheel 46 in relation to headstock 12, sharpening apparatus 110 is operable to sharpen contact surface 98 of welding wheel 46 without relocation of sharpening apparatus 110. More specifically, and as previously described, welding wheel 46 is mounted on welding arm 38. Welding arm 38 is positioned on welding support assembly 40. Support assembly 40 is positioned on support structure 42 and is vertically moveable on support structure 42 by means of the vertical linear actuator system. Support structure 42 is supported on headstock 12 and is laterally moveable in relation thereto by the lateral linear actuator system.

In operation using an embodiment of the present invention, contact surface 98 of welding wheel 46 may be biased in a welding position as depicted in FIG. 5, wherein contact surface 98 is in contact with a wire 22 supported on a rib 20. When it is determined that the contact surface 98 of welding wheel 46 needs to be sharpened, the vertical linear actuator system and the lateral linear actuator systems may be operated concertedly or independently to place contact surface 98 in contact with sharpening system 110 sharpening tip 106. Upon such contact, motor welding arm 38 may be rotated, thereby rotating welding wheel 46, to effectively sharpen surface 98. The lateral linear actuator system may be concurrently operated to laterally move welding wheel 46 in relation to sharpening tip 106, thereby providing a consistent lateral surface of contact surface 98. As the sharpening process is accomplished with the same rotational movement of welding arm 38 as rotational movement of welding arm 38 during welding processes, i.e., is operationally equivalent to the welding process, surface inconsistencies resulting from deviation of welding arm 38 from true circular rotation are minimized.

In one embodiment of the present invention, the movement of welding wheel electrode 46 relative to sharpening apparatus 110 to provide contact surface 98 in a sharpening location is accomplished by a process which comprises movement of all or part of sharpening apparatus 110. In one such embodiment, the vertical and/or lateral position of welding wheel electrode 46 is maintained at or near its welding position, and at least a portion of sharpening apparatus 110 is moved vertically and/or laterally to provide sharpening apparatus 110 in a sharpening location where the sharpening mechanism can engage contact surface 98. A mechanism (not shown) adapted to provide movement of sharpening apparatus 110, which may comprise one or more linear actuators, may be disposed separate from headstock 12 or may be attached thereto. In an embodiment where sharpening apparatus 110 includes a sharpening mechanism that is adapted to engage contact surface 98 from a remote position, such as a water jet or laser, movement of welding wheel electrode 46 and/or sharpening apparatus 110 to provide contact surface 98 in a sharpening location may not be required.

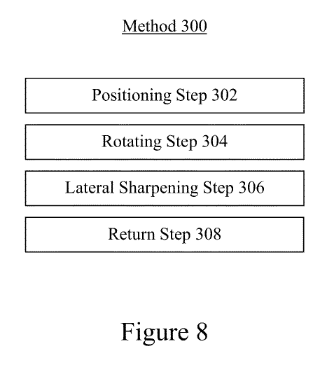

Referring to FIG. 8, an embodiment of a method of a sharpening process 300 of the present invention comprises:

A positioning step 302 of positioning a welding wheel, such as welding wheel 46, proximate a sharpening blade, such as sharpening blade 104.

A rotating step 304 of rotating the welding wheel 46 in relation to the sharpening blade 104.

A lateral sharpening step 306 of laterally moving the welding wheel in relation to the sharpening blade 104 to allow consistent lateral sharpening of the contact surface 98 of the welding wheel 46. In one embodiment, a sharpening tip 106 is utilized to sharpen contact surface 98 of the welding wheel 46.

A return step 308 of returning the welding wheel 46 to a welding position wherein the welding wheel 46 is positioned to be operable for welding operation.

In an exemplary embodiment of the present invention, positioning step 302 comprises vertical and lateral positioning of the welding wheel in relation to a fixed welding blade on a welding arm. In a further exemplary embodiment, the positioning step 302 comprises adjusting vertical position of the welding wheel with the vertical linear actuator system, and further comprises adjusting lateral position of the welding wheel 46 with the lateral linear actuator system.

In an exemplary embodiment of the present invention, rotating step 304 comprises rotating the welding wheel 46 by rotating welding arm 38.

In exemplary embodiment of the present invention, lateral sharpening step 306 comprises lateral movement utilizing the lateral linear actuator system.

In an exemplary embodiment, the return step 308 comprises adjusting vertical position of the welding wheel with the vertical linear actuator system, and further comprises adjusting lateral position of the welding wheel 46 with the lateral linear actuator system.

While preferred embodiments of the invention have been described and illustrated, modifications thereof can be made by one skilled in the art without departing from the teachings of the invention. Descriptions of embodiments are exemplary and not limiting. The extent and scope of the invention is set forth in the appended claims and is intended to extend to equivalents thereof. The claims are incorporated into the specification. Disclosure of existing patents, publications and known art are incorporated herein to the extent required to provide reference details and understanding of the disclosure herein set forth.

We claim:

1. A welding wheel apparatus for a wire wrapping system, comprising:
a welding wheel electrode comprising a contact surface; and
a sharpening mechanism;
wherein said welding wheel apparatus is adapted to provide said welding wheel electrode contact surface in a sharpening location; and
wherein said sharpening mechanism is adapted to engage said welding wheel electrode contact surface provided in said sharpening location.

2. The apparatus of claim 1, wherein said welding wheel electrode is mounted on a support assembly adapted to move said welding wheel electrode to a welding position.

3. The apparatus of claim 1, wherein said welding wheel apparatus is adapted to provide said welding wheel electrode contact surface in said sharpening location by at least one movement selected from the group consisting of:
movement of said welding wheel electrode; and
movement of said sharpening mechanism.

4. The apparatus of claim 3, wherein at least one of said movement of said welding wheel electrode and said movement of said sharpening mechanism comprises movement in a direction selected from the group consisting of:
lateral;
vertical; and
both lateral and vertical.

5. The apparatus of claim 3, comprising at least one linear actuator adapted to produce at least one of said movement of said welding wheel electrode and said movement of said sharpening mechanism.

6. The apparatus of claim 1, wherein said apparatus is adapted to rotate said welding wheel electrode when said sharpening mechanism is in engagement with said welding wheel electrode contact surface.

7. The apparatus of claim 1, wherein said sharpening mechanism comprises a sharpening blade.

8. The apparatus of claim 7, wherein said sharpening blade comprises a sharpening tip.

9. A welding wheel apparatus for a wire wrapping system, comprising:
a welding wheel electrode comprising a contact surface;
wherein said welding wheel electrode is mounted on a support assembly adapted to move said welding wheel electrode to a welding position; and
a sharpening blade;
wherein said support assembly is adapted to move said welding wheel electrode contact surface to a sharpening location; and
wherein said sharpening blade is adapted to engage said welding wheel electrode contact surface moved to said sharpening location.

10. The apparatus of claim 9, wherein said support assembly is adapted to move said welding wheel electrode contact surface to said sharpening location in a direction selected from the group consisting of:
laterally;
vertically; and
both laterally and vertically.

11. The apparatus of claim 9, comprising at least one linear actuator adapted to produce at least one movement selected from the group consisting of:
movement of said welding wheel electrode to said welding position;
movement of said welding wheel electrode contact surface to said sharpening location; and
both movement of said welding wheel electrode to said welding position and movement of said welding wheel electrode contact surface to said sharpening location.

12. The apparatus of claim 9, wherein said apparatus is adapted to rotate said welding wheel electrode when said sharpening blade is in engagement with said welding wheel electrode contact surface.

13. The apparatus of claim 9, wherein said sharpening blade comprises a sharpening tip.

14. A method of sharpening a welding wheel apparatus welding wheel electrode contact surface, comprising:
providing said welding wheel electrode, attached to said welding wheel apparatus, in a welding position;
providing said welding wheel electrode contact surface in a sharpening location, without detaching said welding wheel electrode from said welding wheel apparatus;
providing a sharpening mechanism; and
engaging said sharpening mechanism with said welding wheel electrode contact surface provided in said sharpening location.

15. The method of claim 14, wherein said providing said welding wheel electrode contact surface in said sharpening location comprises moving at least one component selected from the group consisting of:
said welding wheel electrode; and
said sharpening mechanism.

16. The method of claim 15, wherein said moving at least one of said welding wheel electrode and said moving said sharpening mechanism comprises movement in a direction selected from the group consisting of:
lateral;
vertical; and
both lateral and vertical.

17. The method of claim 16, wherein said moving at least one of said welding wheel electrode and said moving said sharpening mechanism comprises utilizing at least one linear actuator.

18. The method of claim 15, wherein said moving said welding wheel electrode comprises moving a support assembly of said welding wheel apparatus.

19. The method of claim 14, comprising rotating said welding wheel electrode when said sharpening mechanism is in engagement with said welding wheel electrode contact surface.

20. The method of claim 14, wherein said sharpening mechanism comprises a sharpening blade.
